(19) United States
(12) Patent Application Publication
(10) Pub. No.: US 2005/0163665 A1
(43) Pub. Date: Jul. 28, 2005

(54) Method and apparatus for dispensing liquids in a micro-grid pattern

(76) Inventors: Walter Gumbrecht, Herzogenaurach (DE); Peter Paulicka, Erlangen (DE)

Correspondence Address: HARNESS, DICKEY & PIERCE, P.L.C., P.O.BOX 8910, RESTON, VA, 20195, US

(21) Appl. No.: 11/023,583

(22) Filed: Dec. 29, 2004

(30) Foreign Application Priority Data
Dec. 29, 2003 (DE) 103 61 399.4

(51) Int. Cl. B01L 3/02

(52) U.S. Cl. 422/100

(57) ABSTRACT

An intention is for liquids to be dispensed in a micro-grid pattern, i.e. at grid spacings of less than 1 mm. Either a single liquid at a plurality of spots or a plurality of different liquids are released to the substrate simultaneously from microcapillaries by way of a simultaneous capillary/liquid/substrate contact, but without capillary/substrate contact. In the associated apparatus, by way of a macro-head and individual macrocapillaries, which are arranged in a macro-grid pattern, the liquid is transferred, via a coupling location, into a dispensing head with microcapillaries. The macrocapillaries are coupled to the microcapillaries, which transfer the liquid into the micro-grid pattern.

The present application hereby claims priority under 35 U.S.C. §119 on German patent application numbers DE 10361399.4 filed Dec. 29, 2003, the entire contents of which is hereby incorporated herein by reference.

### FIELD OF THE INVENTION

The invention generally relates to a method for dispensing liquids in a micro-grid pattern. In particular, it relates to a method for the simultaneous, parallel dispensing (spotting) of different quantities of liquid in the range of <<1 μl in a grid spacing of <1 mm. In addition, the invention also generally relates to the associated apparatus for carrying out the method.

### BACKGROUND OF THE INVENTION

Array technologies are increasingly being used in molecular diagnostics. Hitherto, the titer plate technology in which, for example 96 (8×12) miniaturized reaction vessels at a grid spacing of 9 mm and each having capacities of a few 100 μl are formed in a plastic plate of approx. 127×85×15 mm, has been in widespread use. Titer plates of 384 wells (4.5 mm grid spacing) and 1536 wells (2.25 mm grid spacing) are also known. The reaction vessels can be fed with reagents and analyte substances by the manufacturer or user, thereby allowing parallel analysis or diagnostics.

What are known as micro-arrays are likely to provide a further level of miniaturization, thereby increasing the capacity of parallel analysis or diagnostics. In these micro-arrays, the manufacturer or user applies reagents to a planar substrate, e.g. a glass specimen slide, at a grid spacing of 1 mm or below, and these reagents are then fed for simultaneous analysis.

The coating of the substrates, also known as spotting, can be carried out using various commercially available appliances, known as spotters. A number of methods are available for the spotting:
contact spotters (1 to 4 channel technology “A Silicon-micromachined Pin for Contact Droplet Printing” Jane Gin Fai Tsai, Zugen Chen, Stanley Nelson, and Chang-Jin. C J. Kim IEEE Conf. MEMS, Kyoto, Japan, January 2003, pp. 295-298.): Movable microneedles are used, in a similar way to those in dot matrix printer technology. These microneedles may be smooth or, for example, slotted in order to achieve a higher loading capacity. The needles can be dipped into a reservoir in order to pick up the solution to be spotted or may be combined with a “micro-ear”, with the aid of which solution is picked up from a reservoir and held in the ear on account of surface tension, the solution is picked up when the needle is passed through the ear and then transferred to the substrate. Contact methods are unsuitable for sensitive surfaces. The needles are located at a grid spacing of a few mm (e.g. titer plate grid spacing 9 mm, 4.5 m, 2.25 mm). However, they are unsuitable for simultaneous, parallel spotting in the sub-mm grid spacing.
contactless spotters (GeSim, Microdrop, Packard) (1 to 8 channel technology) (HIGHLY PARALLEL AND ACCURATE NANOLITER DISPENSER FOR HIGH-THROUGHPUT SYNTHESIS OF CHEMICAL COMPOUNDS, Presented on the IMEMS Workshop 2001 in Singapore, 4-6-Jul. 2001): These spotters operate with pulsed pressure technology, e.g. by way of piezoelectric actuators in combination with micronozzles. However, when the flying drops leave the nozzle, their direction of flight may scatter, thereby leading to geometric inaccuracies through satellite formation in individual cases even to the extent of contaminating neighboring positions. The problem of satellite formation is known from the specialist literature. Furthermore, methods with free-flying drops are greatly restricted in terms of the viscosity and surface tension of the spotable substances which can be selected. The dispensing solution has to be sucked in from the spotting nozzle. The same drawbacks apply for simultaneous parallel spotting as for the contact spotters.
pseudo-contact spotters (SPI www.spi-robot.de, Scientific Precision Instruments GmbH, Oppenheim) (1 to 96 channel technology): An accurate geometry of the spotting pattern without damaging the surface is achieved with pseudo-contact spotters in which a liquid drop emerging from a dispensing cannula produces contact with the surface to be spotted before the dispensing cannula retracts. In one known embodiment, a plunger without any dead spaces is integrated in the dispensing cannula, so that the total diameter is approx. 1 to 2 mm and therefore likewise only grid spacings of, for example, 2.25 mm can be achieved. The dispensing solution has to be sucked in from the spotting nozzle.
integrated contactless spotters: Application Report MF 0404, TopSpot-High-Speed Production of Biochips (HSG-IMIT Institut für Mikro- und Informationstechnik, Villingen-Schwenningen) describes an integrated method in which grid spacings of less than 1 mm down to 0.5 mm are possible and simultaneous parallel spotting can be realized. The dispensing solution is fed to the system “from behind” in small reservoirs. However, since this method is a contactless method with free-flying drops, the same drawbacks apply as have already been listed above: In particular, drift, satellites, restrictions in viscosity and surface tension may arise.

### SUMMARY OF THE INVENTION

Working on this basis, it is an object of an embodiment of the invention to avoid at least one of the drawbacks of the above known methods and to propose a solution for a simple, inexpensive and reliable method. Preferably, the solution is gentle on the surface, for simultaneously discharging a plurality of spots, if appropriate of different substances, which is suitable for an industrial manufacturing process. In one embodiment, it is also intended to provide a suitable apparatus.

An object may be achieved with regard to an embodiment of the method Refinements of the method and the associated arrangement are provided throughout the disclosure.

The method according to an embodiment of the invention can allow for extremely small quantities of liquid to be transferred into the predetermined grid pattern. In the apparatus according to an embodiment of the invention, for this purpose there is at least one device having microcapillaries in a grid spacing of less than 1 mm, which may be realized either in 1-dimensional form (1-D) or in two-dimensional form (2-D). In the former case (1-D), the microcapillaries may be arranged in rows and columns, whereas in the latter case (2-D) the microcapillaries may be arranged in a row. In the apparatus according to an embodiment of the invention, there is at least one microelement for providing a defined geometric arrangement of the microcapillary tips, at least one device with macrocapillaries in a larger 1-D or 2-D grid spacing (e.g. 4.5 mm), at least one macroelement for providing a defined geometric arrangement of the macrocapillary tips and a macroelement for providing a defined geometric arrangement of the microcapillary inlet openings.

In an embodiment of the invention, the macrocapillaries may be advantageously coupled to the microcapillaries via a coupling mechanism that can be disconnected. In this arrangement, at least one pump device may be connected to each macrocapillary, and there may be a controller for controlling the flow of liquid. The overall arrangement has a robot-controlled device which allows the mobility and therefore accurate positioning of the system with the microcapillary tips separated in the x, y and z axes.

### BRIEF DESCRIPTION OF THE DRAWINGS

Further details and advantages of the invention will emerge from the following description of figures relating to exemplary embodiments with reference to the drawings in combination with the patent claims, in which:

FIG. 1 diagrammatically depicts the principle of parallel spotting in a grid spacing of <1 mm,

FIG. 2 shows a diagrammatically depicted apparatus having microcapillaries and macrocapillaries in a 2-D array,

FIG. 3 shows a diagrammatically depicted arrangement of macrocapillaries with pump devices and coupling location for the microcapillaries,

FIGS. 4a to 4g show a diagrammatically depicted dispensing sequence in individual substeps, and

FIG. 5 shows an exemplary embodiment of the coupling location between a macrocapillary and a microcapillary.

### DETAILED DESCRIPTION OF THE EXEMPLARY EMBODIMENTS

For use in in-vitro diagnostics, an array of individual spots may be produced for a biochip. The individual spots are located on a substrate and include a capture device, on which the molecules can dock in accordance with the key/lock principle during the subsequent biochemical analysis. A suitable spotting solution may be used to produce the spot array. Furthermore, technical devices/methods for dispensing may be used to discharge the spots, for example at a micrometer spacing, onto the substrate.

For the latter purpose, a method may be provided for the simultaneous, parallel dispensing of different liquids in a micro-grid pattern, using an arrangement of macrocapillaries in a macro-grid pattern which are used to load the microcapillaries. This purpose may be served by the apparatus described below having microcapillaries which are held in the dispensing grid pattern by a microelement. The inlet openings of the microcapillaries and the outlet openings of the macrocapillaries may be held in a titer plate grid pattern by a macroelement. Two macroelements form the coupling location.

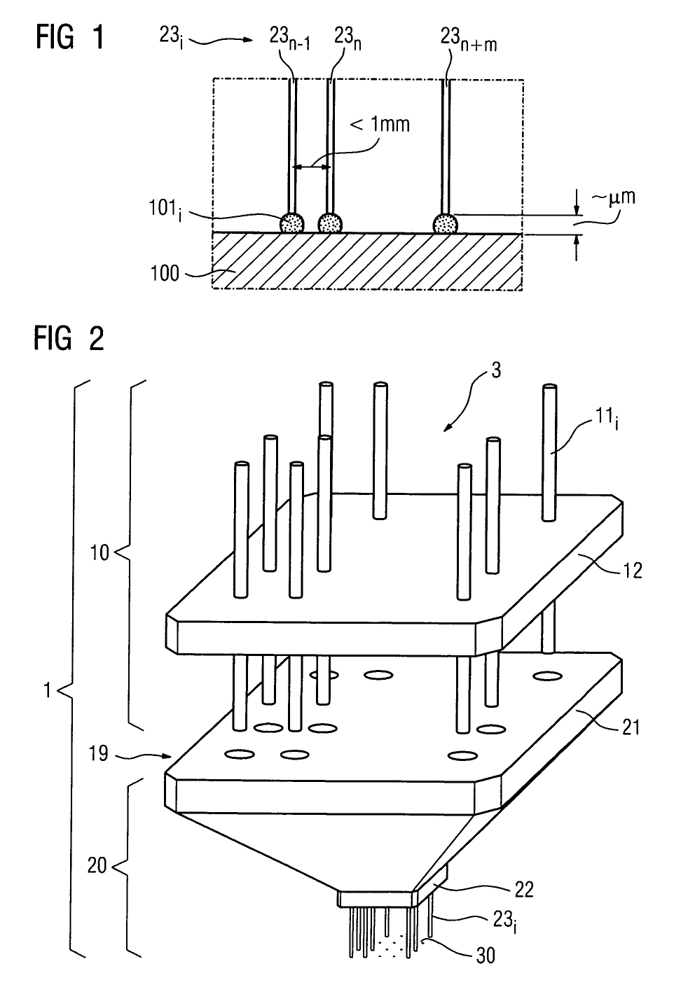

First of all, the problem to be overcome will be explained with reference to FIG. 1. 100 denotes a substrate to which extremely small quantities of a dispensing liquid, specifically significantly less than 1 ml, at least in the μl range, but in particular even down into the nanoliter range, are to be applied. This operation is known as spotting, with the spotted liquids forming what is known as a spot grid pattern or array.

Spots 101ᵢ, i.e. single spots 101ₙ₋₁, 101ₙ to 101ₙ₊ₘ, are shown on the substrate 100 in FIG. 1. Microcapillaries are required for discharging the spots 101ᵢ on the substrate 100, these microcapillaries being designated below in the description of the apparatus by 23ᵢ and in FIG. 1 being numbered consecutively as 23_{n-1, 23}ₙ, 23ₙ₊₁, . . . to 23ₙ₊ₘ.

An important factor in the method described here is that the spotting is effected by simultaneous capillary/liquid/substrate contact but without capillary/substrate contact. For this purpose, the capillaries have to be automatically moved to the substrate in the μm range, for example to within 1/10 μm, in order to allow accurate spotting.

Although spotting with capillary/liquid/substrate contact is known per se from the prior art cited in the introduction, in this prior art it is only possible to produce spots with a relatively large spacing, but not in a grid pattern with a grid spacing of <1 mm. To achieve this objective, in particular the capillaries 23i in the end region have to be guided parallel and form the two-dimensional micro-grid pattern with the capillary ends.

FIG. 2 illustrates the overall arrangement which can be used to transfer liquid from a macro-grid pattern 3 into a micro-grid pattern 30 and which is denoted by 1. The arrangement 1 includes a first macro-head 10 with macrocapillaries 11 which are held in a macroelement 12. There is a dispensing head 20 which has a second macroelement 21 which is formed approximately mirror-symmetrically with respect to the first macroelement 12 and has a receiving device for the macrocapillaries 11 of the first macroelement 12. In this way, a coupling location 19 is formed. The dispensing head 20 having the second macroelement 21 narrows to form a microelement 22 with individual microcapillaries 23′ which form the micro-grid pattern 30.

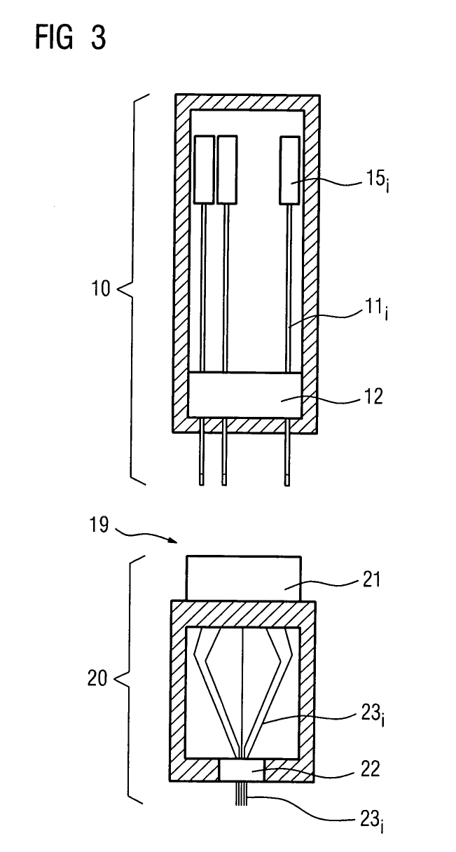

FIG. 3 shows a sectional illustration of macro-head 10 and dispensing head 20 in section. An important factor is that in macro-head 10 the macrocapillaries 11 are guided by way of the macroelement 12, with individual pumps 15 in each case being present at the rear side of the macrocapillaries 11. Microcapillaries 23i, into which the quantities of liquid are transferred from the macrocapillaries 11, are present in the dispensing head 20 with second macroelement 21 and coupling location 19. The microelement 22 is provided for holding the microcapillaries in the defined grid pattern.

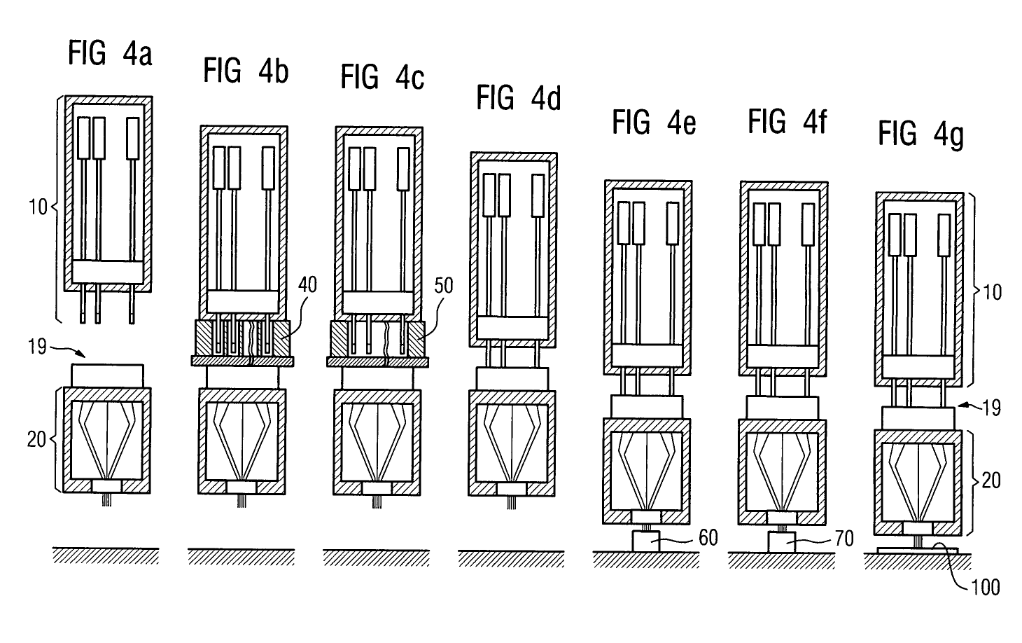

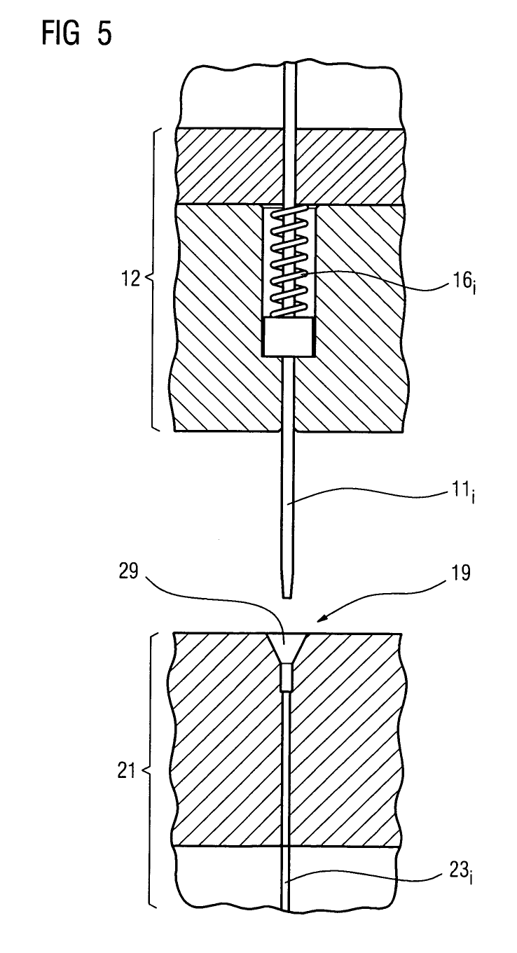

Individual working steps of the arrangement shown in FIGS. 2 and 3 are reproduced in FIG. 4 on the basis of subfigures 4a to 4g. These working steps are explained in detail below with reference to the description of operation. Before this, for the sake of completeness, FIG. 5 will be dealt with.

FIG. 5 illustrates the structure of the macroelement 12 from FIG. 1. The important factor here is that the macrocapillaries 11ᵢ are each guided against a spring 16i in order to simplify coupling at the coupling location 19. For this purpose, the coupling location 19 is of funnel-shaped design 29. It can also be seen that in the second macroelement the liquid is transferred into the microcapillaries 23i.

To advantageously realize the simultaneous, parallel dispensing, the following detailed procedure is adopted: the liquid is transferred from the macro-head 10 to the dispensing head, the dispensing head 20 being designed with at least one microcapillary 23 in such a way that it can work with a plurality of microcapillaries in parallel simultaneously. The microcapillary outlet openings are held in a defined dispensing grid pattern by way of a microelement, for example in the form of micro-openings which predetermine the dispensing grid pattern.

The dispensing grid pattern may, for example form a microarray 30 which is arranged with a two-dimensional grid spacing dimension of 400×400 μm. A microelement array 30 of this type has several tens of up to approx. 100 positions. The microelement openings have virtually the same (≧) diameter as the outer microcapillary diameter, which leads to the microcapillaries being held with micrometer accuracy in the dispensing grid pattern. The microcapillaries 23 are, for example, placed in the microelement in such a manner that the microcapillary outlet openings project a few millimeters (1 to 3 mm) out of the microelement and that there is a space for free drop formation for each of the individual microcapillaries 23i.

It is necessary to ensure that all the outlet openings of the microcapillaries 23i are arranged in one plane. The inlet openings of the microcapillaries 23i are simultaneously held in the titer plate grid spacing of, for example, 4.5 mm with the aid of the second macroelement 21.

As described, there is a macro-head 10 in the arrangement. The macro-head 10 is formed by the macrocapillaries 11ᵢ in a macro-grid pattern, each individual macrocapillary 11ᵢ being connected to the separate precision pump 15ᵢ. The overall arrangement including dispensing head 20 and macro-head 10 is realized in one axis, with at least one element of the dispensing head 20 or macro-head 10 being able to move freely in this axis. The macrocapillary outlet openings are held in a defined titer plate grid pattern by way of the first macroelement 12, for example in the form of openings which predetermine the titer plate grid pattern.

The titer plate grid pattern, may, for example, be in the form of an array which is provided with a two-dimensional grid spacing of 4.5×4.5 mm. The macroelement array 3 has the same number of positions as are to be realized in the dispensing head 20. The openings of the macroelements have a virtually identical (>=) diameter to the outer macrocapillary diameter, which leads to the macrocapillaries being held with macrometer accuracy in the titer plate grid pattern. The macrocapillaries 11ᵢ are, for example, positioned in such a manner in the first macroelement 21 that the macrocapillary outlet openings project a few millimeters (10 to 15 mm) out of the macroelement 21, so that each individual macrocapillary 11ᵢ can move freely into a titer plate opening.

It is necessary to ensure that all the macrocapillary outlet openings are arranged in one plane and that each individual macrocapillary can be sprung by way of a mechanism realized in the macroelement.

For practical implementation of the new dispensing method, the dispensing head 20/macro-head 10 structure is secured to a positioning mechanism with a plurality of robot axes, allowing mobility and accurate positioning. This system may, for example, have two horizontal axes, which are responsible for changing the position of the microcapillary outlet openings in the horizontal plane (x, y axes), and one vertical axis, which is designed to change the position of the microcapillary outlet openings in the vertical plane (z axis). To allow the macro-head to be disconnected from the dispensing head, a further vertical axis (z′ axis) is required, which together is oriented as a macro-head—z′ axis—dispensing head system with respect to the z axis.

Before commencing operation of the system, the macro-head 10 or the macrocapillaries 11ᵢ and pumps 15ᵢ has/have to be filled with system liquid, which performs the function of transporting and washing medium for the microcapillaries 23. The system liquid has to be introduced without any inclusions of gas so that it can be ensured that there is no undesirable compression of the system liquid in the closed system including pump 15—macrocapillary 11. This operation, i.e. the (system liquid filling) is repeated if appropriate if gas has unexpectedly formed in the system or if the system has been contaminated with the dispensing solution. The system liquid has to have a good solubility for the dispensing solution so that it can also be used as washing medium.

Then, a computer-controlled dispensing operation is realized. The dispensing operation is illustrated with reference to FIGS. 4a to 4g: in the starting position corresponding to FIG. 4a, the system is in a parked position, the dispensing head 20 and the macro-head 10 in this position being disconnected. The macrocapillaries 11ᵢ have been filled with the system liquid as far as the outlet openings, and are ready to suck in the dispensing solution.

By way of example, a 384-well titer plate is used (16×24 chambers at a grid spacing of 4.5 mm), and this plate is filled with various dispensing solutions in such a way that the dispensing solutions coincide with the macrocapillary pattern. The amount of solution introduced into one titer plate chamber may, for example, be 15 μl. The titer plate is placed onto a preprogrammed location.

In the disconnected state of the macro-head 10—dispensing head 20 system in accordance with FIG. 4b, it is possible, to move to the titer plate 40 in a defined way, to lower the macro-head by the z′ axis until it has been immersed in the dispensing solution. The dispensing solution is sucked into the macrocapillaries 11ᵢ in a defined quantity (e.g. 10 μl) with the aid of the pumps 15ᵢ. The total volume of the macrocapillaries 11ᵢ is designed such that only approx. ¼ of the macrocapillaries 11ᵢ is filled with the dispensing solution, while a further ¾ of the macrocapillaries 11ᵢ is filled with the system liquid.

In a further step corresponding to FIG. 4c, the macrocapillaries 11ᵢ have been pulled out and moved to a new location which serves as washing station 50 for the macrocapillaries 11ᵢ. This location is filled with solvent. The outer walls of the macrocapillaries 11ᵢ are contaminated after they have been immersed in the dispensing liquid and have to be repeatedly dipped into washing liquid from the outside at this location in order thereby to be washed.

After this step, it is possible to move to a parked position corresponding to FIG. 4a. At this location, the macro-head 10 is moved down via the z′ axis until, in accordance with FIG. 4d, the macrocapillaries 11ᵢ have reached the coupling location 19 at the dispensing head 20 and form a seal by way of the spring force of the macrocapillaries. Then, the entire system can move to a predefined location which is designed to continue the operation of washing the microcapillary outlet openings.

This location 60 is filled with solvent in accordance with FIG. 4e. The microcapillaries 23 projecting out of the microelement 22 are immersed in the solvent. The microcapillaries 23 can then be filled with the dispensing solution by the pumps 15 pumping the dispensing solution through the macrocapillaries 11 into the microcapillaries 23. A defined volume of the dispensing solution which fills the microcapillaries 23i is pumped. Then, the pumps 15ᵢ are stopped and the microcapillary outlet openings are washed with a repeated movement of the z axis.

In a drying station 70, in accordance with FIG. 4f, residues of the solvent are removed from the washed microcapillary outlet openings by these residues being sucked off using a vacuum. After this procedure, the system is ready to carry out the simultaneous, parallel dispensing of different liquids onto a substrate.

Before dispensing onto an intended substrate, a feed location is moved to, which is used to cover the microcapillary outlet openings with uniform drops of the dispensing solution. This simulates a continuation of dispensing by the pumps 15ᵢ delivering an accurately defined volume of the dispensing solution (1 μl down to approx. 1 nl).

The drops formed on the microcapillary outlet openings are discharged onto the feed substrate at uniform time intervals by realizing contact with the feed substrate via the drops. This is effected by movement on the z axis. To ensure that it is impossible for liquid to be discharged onto the same location a number of times, the macro-head 10—dispensing head 20 system is moved using the x-y axes. This operation is repeated a number of times until uniform drops of the dispensing liquid have formed at all the microcapillaries.

The system is now ready for dispensing onto a final substrate in accordance with FIG. 4g. It is moved to a predetermined location on the substrate. This location may, for example, be defined and automated with the aid of a laser pointer, camera image or the like. It is also possible to select a dispensing pattern if it is desired to discharge onto the substrate a number of times.

The dispensing operation is carried out by the pumps delivering an accurately defined volume of the dispensing solution (1 μl to approx. 1 nl). The drops formed at the microcapillary outlet openings are discharged onto the feed substrate at uniform time intervals by realizing contact with the feed substrate via the drops, associated with a movement on the z axis. To allow a defined pattern to be realized, the macro-head—dispensing head system is moved using the x, z axes.

After the dispensing operation, the macro-head 10—dispensing head 20 system is washed in accordance with FIG. 4f. The remaining dispensing solution is pumped out in the washing station by the system liquid together with the dispensing solution in the pumps and macrocapillaries being pumped out through the microcapillaries.

This is followed by movement to the washing station for the macrocapillaries in accordance with FIG. 4c. Here, the outer sides of the macrocapillaries are washed and the system liquid is introduced again from the washing station, for example by suction.

The program ends in a parked position and the system is ready for further use.

The method described and the associated apparatus can be used in particular to process spotting solutions, as are described in the German patent application bearing application number 103 61 395.1-52 “Verfahren und Spotting-Lösung zum Herstellen von Microarrays” [Method and spotting solution for producing microarrays], the entire contents of which are hereby incorporated herein by reference, and which has the same application priority, in particular for the production of biochips. Further, the entire contents of corresponding U.S. application entitled “PROCESS AND SPOTTING SOLUTION FOR PREPARING MICROARRAYS”, and filed on the same date as the present application, are also incorporated herein by reference.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for dispensing liquids in a micro-grid pattern, comprising:
releasing at least one of a single liquid at a plurality of spots, and a plurality of different liquids, to the substrate simultaneously from microcapillaries by way of a simultaneous individual capillary/liquid/substrate contact, but without capillary/substrate contact.

2. The method as claimed in claim 1, wherein quantities of liquid are released from macrocapillaries to the microcapillaries.

3. The method as claimed in claim 1, wherein volumes of liquid, which correspond to a multiple of dispensing volumes, are removed from reservoirs with the aid of the macrocapillaries.

4. The method as claimed in claim 1, wherein outer sides of the macrocapillaries are washed, wherein at least one of the macrocapillaries and the array of macrocapillaries then pass, by way of a coupling device, to at least one of the microcapillaries and the array of microcapillaries, from which the dispensing quantities are discharged onto the substrate.

5. The method as claimed in claim 1, wherein the microcapillaries are filled with the dispensing substances and rinsed.

6. The method as claimed in claim 1, wherein, before the dispensing solutions are discharged, the outlet openings of the microcapillaries are washed in a washing station and dried.

7. The method as claimed in claim 1, wherein, prior to the actual dispensing operation, a predefined feed location is moved to, with the discharge of extremely small dispensing drops being transferred to the feed section via liquid contact with the substrate, thereby achieving balanced pressure conditions.

8. The method as claimed in claim 1, wherein, for the dispensing operation, a predefined location on the substrate is moved to and transferred by discharging extremely small dispensing drops via liquid contact with the substrate.

9. The method as claimed in claim 1, wherein the unused dispensing liquid is flushed out in the washing station and then the microcapillaries, following the dispensing operation, are washed in the washing station using the washing liquid from the macrocapillaries.

10. An apparatus for the simultaneous, parallel dispensing of small quantities of liquid in a grid pattern, comprising:
microcapillaries for distributing quantities of liquid in the range of <<1 μl down to approximately 1 nl in a grid spacing of lower than <1 mm down to approximately 100 μm, wherein outlet openings of the microcapillaries are arranged in a dispensing grid pattern.

11. The apparatus as claimed in claim 10, wherein inlet openings of the microcapillaries are arranged in a relatively larger grid pattern.

12. The apparatus as claimed in claim 11, wherein the outlet openings of the microcapillaries are arranged in a relatively smaller grid pattern.

13. The apparatus as claimed in claim 10, wherein quantities of liquid are set to be released from macrocapillaries to the microcapillaries, and wherein outlet openings of macrocapillaries are arranged in the same grid pattern as inlet openings of the microcapillaries.

14. The apparatus as claimed in claim 10, wherein inlet openings of the microcapillaries are connectable to the outlet openings of macrocapillaries by reversible coupling mechanisms.

15. The apparatus as claimed in claim 10, wherein quantities of liquid are set to be released from macrocapillaries to the microcapillaries, and wherein the macrocapillaries are connectable to pump devices.

16. The apparatus as claimed in claim 10, wherein an arrangement including the microcapillaries, coupling mechanisms and macrocapillaries is movable in at least one spatial direction.

17. The apparatus as claimed in claim 10, wherein quantities of liquid are set to be released from macrocapillaries to the microcapillaries, and wherein the macrocapillaries and the microcapillaries are arranged in a one-dimensional system.

18. The apparatus as claimed in claim 10, wherein quantities of liquid are set to be released from macrocapillaries to the microcapillaries, and wherein the macrocapillaries and the microcapillaries are arranged in a two-dimensional system.

19. The apparatus as claimed in claim 10, wherein the microcapillaries are held in a defined position in the dispensing grid with the aid of a microelement.

20. The apparatus as claimed in claim 10, wherein quantities of liquid are set to be released from macrocapillaries to the microcapillaries, and wherein macrocapillaries are held in a defined position in the titer plate grid with the aid of the macroelement.

21. The apparatus as claimed in claim 10, wherein macrocapillaries, in a state in which they are disconnected from the microcapillaries, are connectable to an array of liquid reservoirs.

22. The apparatus as claimed in claim 10, wherein quantities of liquid are set to be released from macrocapillaries to the microcapillaries, and wherein an arrangement of macrocapillaries is filled with a transport liquid.

23. The apparatus as claimed in claim 22, wherein the transport liquid is free of compressible substances.

24. The apparatus as claimed in claim 10, wherein the dispensing solution is transferrable by way of liquid contact with the substrate.

25. The apparatus as claimed in claim 10, wherein the discharging of dispensing liquid onto the substrate is repeatable a number of times.

26. The apparatus as claimed in claim 10, wherein quantities of liquid are set to be released from macrocapillaries to the microcapillaries, and wherein the macrocapillaries are connected to a system which allows the movement of the liquid.

27. The apparatus as claimed in claim 26, wherein quantities of liquid are set to be released from macrocapillaries to the microcapillaries, and wherein the system simultaneously moves the liquids in a defined way in at least one of all the macrocapillaries and microcapillaries.

28. The apparatus as claimed in claim 10, wherein quantities of liquid are set to be released from macrocapillaries to the microcapillaries, and wherein the system includes a number of precision syringes corresponding to the number of macrocapillaries.

29. The apparatus as claimed in claim 28, wherein the system includes a number of piezo pumps corresponding to the number of at least one of macrocapillaries and microcapillaries.

30. The apparatus as claimed in claim 28, wherein the system includes a number of peristaltic pumps corresponding to the number of at least one macrocapillaries and microcapillaries.

31. The method of claim 1, wherein the method is for the simultaneous and parallel dispensing of different quantities of liquid in the range of <<1 μl in a grid spacing of <1 mm on the substrate.

32. The method of claim 1, wherein the releasing includes simultaneous and parallel dispensing of different quantities of liquid in the range of <<1 μl in a grid spacing of <1 mm on the substrate.

33. The apparatus as claimed in claim 10, wherein inlet openings of the microcapillaries are arranged in the 4.5 mm grid spacing of a 384-well titer plate.

34. The apparatus as claimed in claim 10, wherein the outlet openings of the microcapillaries are arranged in a 0.5 mm grid spacing.

35. The apparatus as claimed in claim 33, wherein the outlet openings of the microcapillaries are arranged in a 0.5 mm grid spacing.

36. The apparatus as claimed in claim 10, wherein the substrate to be spotted is feedable to the arrangement.

37. The apparatus as claimed in claim 16, wherein the substrate to be spotted is feedable to the arrangement.

38. The apparatus as claimed in claim 10, wherein quantities of liquid are released from macrocapillaries to the microcapillaries.

39. An apparatus for the simultaneous, parallel dispensing of small quantities of liquid in a grid pattern, comprising:
means for releasing quantities of liquid; and
means for receiving the quantities of liquid and for distributing quantities of liquid in the range of <<1 μl down to approximately 1 nl in a grid spacing of lower than <1 mm down to approximately 100 μm, wherein outlet openings of the means for receiving are arranged in a dispensing grid pattern.

40. The apparatus as claimed in claim 39, wherein the means for releasing includes macrocapillaries and the means for receiving includes microcapillaries.
